(19) United States
(12) Patent Application Publication
(10) Pub. No.: US 2005/0263187 A1
(43) Pub. Date: Dec. 1, 2005

(54) Check valve barbed casing

(76) Inventors: Jay M. Jernigan, San Jose, CA (US); Cyrus Kliewer, San Jose, CA (US); Michael McGregor, Scotts Valley, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 10/857,672

(22) Filed: May 28, 2004

(51) Int. Cl. F16K 51/00

(52) U.S. Cl. 137/454.2

(57) ABSTRACT

A check valve is disclosed which may be anchored in place through the use of a barbed casing.

### BACKGROUND OF THE INVENTION

1. Field of the Invention

The present invention relates to check valves for one-way flow control and pressure relief within tubing, and in particular to check valves which may be anchored in place through the use of a barbed casing and check valves including components having a straightforward and simple design allowing the components to be scaled down to an extremely small size without losing functionality or performance of the check valve.

2. Description of the Related Art

Check valves are used in a wide variety of applications to provide accurate, reliable one-way fluid flow control and pressure relief. Applications in which check valves are typically used include medical diagnostic and treatment equipment, gas analysis equipment, filtration, beverage dispensing, semiconductor fabrication, chemical processing and many others.

While many configurations are known, a typical check valve is comprised of an annular disc, or poppet, mounted for axial translation within the cavity of a housing. A biasing mechanism such as a spring is provided to bias the poppet into a sealing position which prevents fluid flow through the valve. When mounted in a pipe, tubing or other fluid flow conduit, fluid flow acting on the poppet in the same direction as the force exerted by the biasing mechanism further increases the pressure on the seal to prevent fluid flow in that direction. On the other hand, fluid flow of sufficient pressure acting on the poppet in the opposite direction as the force exerted by the biasing mechanism overcomes the force of the spring to move the poppet out of its seat to thereby create a path for fluid to flow through the valve. The pressure at which fluid overcomes the force of the spring to unseat the poppet and allow flow through the valve is referred to as the cracking pressure.

One problem in conventional check valves relates to mounting the valve within the flow conduit. Conventional valves that are merely seated in a pipe or tubing tend to dislodge and move under fluid pressure. While it is known to machine a cavity into the conduit for seating the valve, such machining is adds time and expense to the provision of the valve.

Another problem with conventional check valves is that the moving parts are not easily scaled down for small inner diameter (“id”) conduits. As the applications in which check valves are used call for smaller and smaller conduit ids, redesign of the check valve has become necessary.

### SUMMARY OF THE INVENTION

It is therefore an advantage of embodiments of the present invention to provide a check valve which may easily and quickly mounted in a fixed position within a conduit without machining.

It is a further advantage of the present invention to provide a check valve having a range of reliable and controllable cracking pressures.

These and other advantages are provided by the present invention, which in embodiments relate to a check valve including a barbed casing for fitting within a conduit. Internal components are provided substantially within the barbed casing which are capable of moving between a first position where fluid flow is allowed through the barbed casing and a second position where fluid flow is prevented through the barbed casing, fluid flow in one direction biasing and maintaining the internal components in the first position and fluid flow in the opposite direction biasing the internal components into the second position. The barbs provided on the outer surface of the casing maintain the check valve in a fixed position at which the check valve is inserted in the conduit.

### BRIEF DESCRIPTION OF THE DRAWINGS

The present invention will now be described reference the drawings, in which:

FIG. 1 is a side view of a conduit such as tubing including a check valve according to the present invention held securely therein;

FIG. 2 is an exploded perspective view of a check valve according to an embodiment of the present invention;

FIG. 3 is a perspective view of an assembled check valve according to the present invention;

FIG. 4 is a cross-sectional side view of the check valve according to an embodiment of the present invention;

FIG. 5 is a side view of a conduit such as tubing including a check valve according to an alternative embodiment of the present invention;

FIG. 6 is an exploded perspective view of the check valve according to alternative embodiment shown FIG. 5; and

FIG. 7 is a cross-sectional side view of the check valve according to the embodiment of FIG. 5.

### DETAILED DESCRIPTION

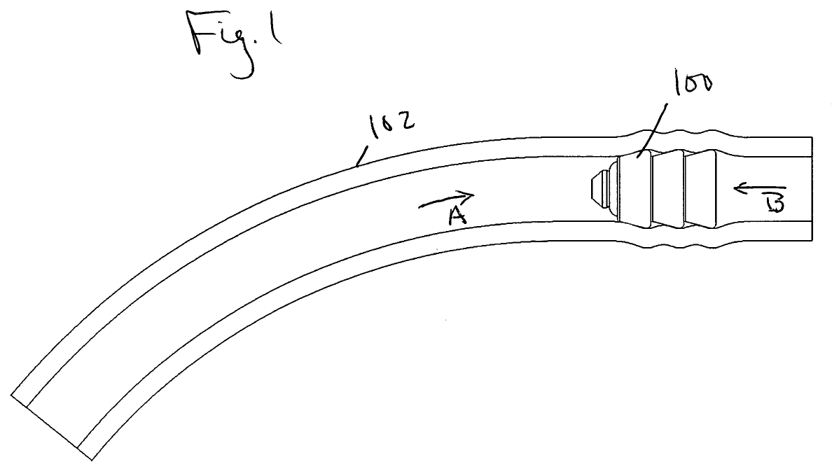

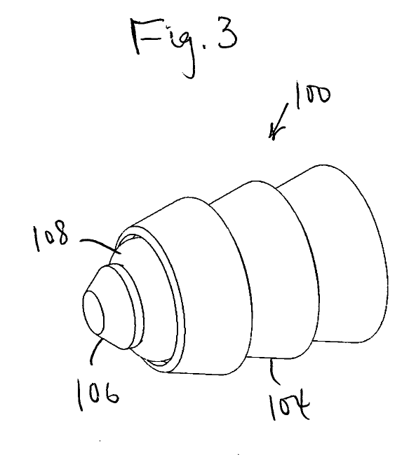

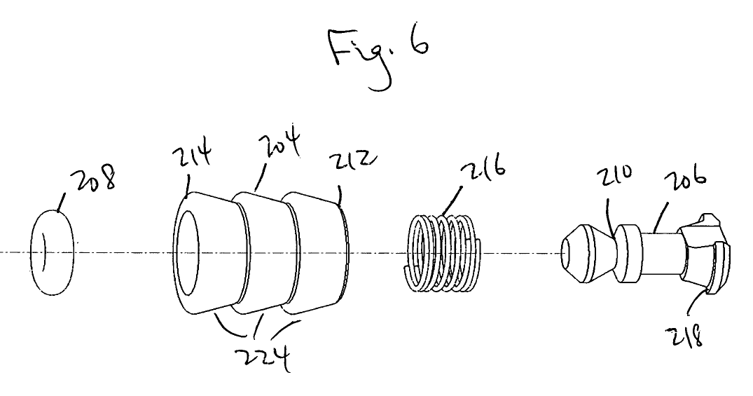

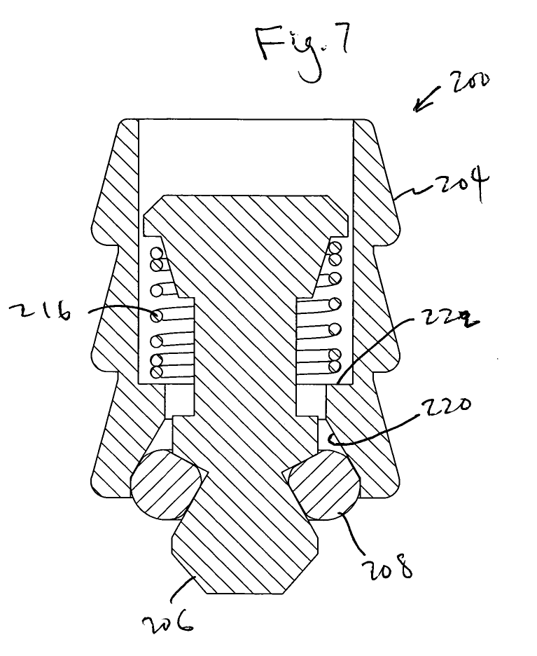

The present invention will now be described with reference to FIGS. 1 through 7, which embodiments relate to check valve which may be securely located within a conduit and which has a design capable of operating in narrow ID conduits. It is understood that the present invention may be embodied in many different forms and should not be construed as being limited to the embodiments set forth herein. Rather these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

Referring now to FIG. 1, there is shown a check valve 100 fixedly seated within a conduit 102. Conduit 102 may for example be polymer tubing such as polytetrafluoroethylene (PTFE) tubing. However, it is understood the conduit 102 may be formed of other materials used for tubing, pipes and other conduits in which embodiments of the present invention is provided. Moreover, the check valve 100 may be mounted within a variety of other mounting designs, such as fittings and manifolds. As will be explained hereinafter, check valve 100 has a construction which anchors it into the position in which it is inserted within conduit 102, and remains there after insertion and during use.

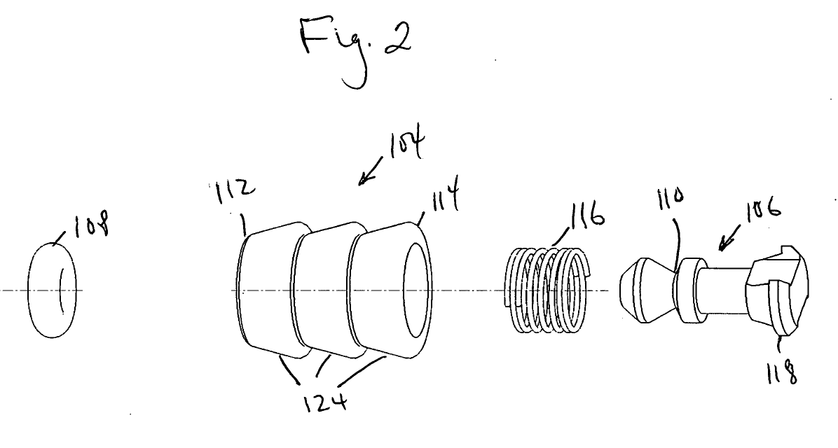

Referring now to FIGS. 2 through 4, check valve 100 is comprised of a casing 104 within which is seated a poppet 106 and an O-ring 108 which, when assembled, sits securely within a slotted neck portion 110 on poppet 106 so that fluid is prevented from flowing between the adjoining surfaces of the O-ring and poppet. Casing 104 has a front end 112 (i.e., the end of casing 104 first inserted into conduit 102) and a back end 114. A spring 116 is further provided to bias the check valve into a closed position whereby fluid flow through the check valve is prevented as explained hereinafter.

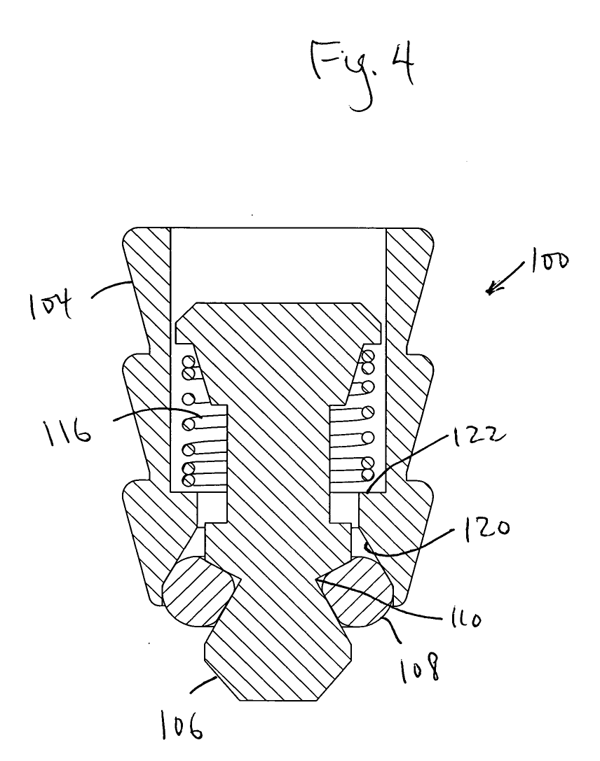

Check valve 100 is constructed by placing spring 116 over poppet 106 until an end of the spring abuts against a flange 118 formed in back end of the poppet 106. The poppet 106 and spring 116 are then inserted through the back end 114 and into an interior cavity of casing 104. Once positioned within the interior cavity, O-ring 108 is press-fit onto poppet 106 in slotted neck 110 at the front end 112 of casing 104. As seen for example in FIG. 4, the interior cavity of casing 104 at front end 112 has a seat 120 which gets narrower away from the front end 112. The seat 120 may be conical or other shape. The seat 120 narrows to a diameter which is smaller than the outer diameter the O-ring 108. Thus, O-ring 108 may seat snugly within seat 120 to prevent fluid flow between the O-ring and the seat 120.

As indicated above, when inserted into casing 104, spring 116 has a back end supported against a flange 118 in poppet 106. A front end of the spring is supported against a lip 122 formed on an interior surface of casing 104. Thus, once poppet 106 is inserted into casing 104 and O-ring is fit onto poppet 106, spring 116 biases the poppet toward the back end 114 of casing 104 to seat O-ring 108 firmly and securely within seat 120 to prevent flow through check valve 100. Referring again to FIG. 1, fluid flow in the direction of arrow A will act to more firmly force O-ring 108 against seat 120 to prevent fluid flow through check valve 100 in that direction. However, fluid flow in the direction of arrow B at a pressure great enough to overcome the force exerted by spring 116 (i.e., the cracking pressure) will unseat O-ring 108 from seat 120 to allow fluid flow in that direction.

In an embodiment of the present invention, the cracking pressure may for example range between 0.5 psi to 20 psi in alternative embodiments of the check valve. It is understood that the cracking pressure of check valve 100 may be less than 0.5 psi and greater than 20 psi in alternative embodiments. The cracking pressure of check valve 100 for fluid flow in the direction of arrow B may be precisely controlled by controlling the length of check valve 100 and spring 116 as well as the spring constant of spring 116.

The casing 104 and poppet 106 may be formed of various polymers such as for example polypropylene in embodiments of the present invention. The casing 104 and/or poppet 106 may be formed of a variety of other materials in alternative embodiments including for example nylon, acrylic, Delrin®, PVDF, polycarbonate and Ultem®. Still further materials may include various rubbers and elastimers. O-ring 108 may be formed of Buna-N, but may be formed of other materials in alternative embodiments such as for example ethylene, propylene, Viton®, Alfas and Kalrez®. Spring 116 may for example be 316 stainless steel standard. Other spring materials are contemplated.

In order to maintain the check valve 100 in the fixed position at which the check valve is inserted into conduit 102, casing 104 includes one or more barbs 124. Each barb is formed of a conical section having a diameter which increases from the front to the back of the conical section as shown in the figures. The smaller diameter front sections allows the barbed housing to be inserted into a conduit 102, but the larger diameter back sections prevent the casing from moving once positioned. The check valve is shown with the barbs being inserted into conduit 102 with the narrower portion of the barb inserted first. It is understood that the wider portion of the barb may be inserted first in alternative embodiments.

In embodiments of the present invention, check valve 100 may be used in conduits having an inner diameter of approximately one-quarter inch. For such embodiments, the narrower sections of each barb may be approximately one-quarter inch outer diameter, while the large sections of the barb may be slightly larger than one-quarter inch outer diameter, such as for example five-sixteenths of an inch.

It is understood that check valve 100 may be sized to fit within conduits larger or smaller than one-quarter inch in alternative embodiments. Moreover, it is understood that the size difference of the narrower and wider sections of each barb 124 relative to the inner diameter of the conduit may be greater or lesser than that described above. In the embodiment shown, casing 104 includes three barbed sections 124. It is understood that there may be greater than or less than three barbed sections in alternative embodiments of the present invention. Moreover, while each of the three barbed sections is shown as being identical to each other, it is understood that the barbed sections need not be identical to each other in alternative embodiments of the present invention. In the embodiment shown, all portions of the barbs 124 have an annular cross-section in a plane perpendicular to the longitudinal axis of the casing. It is understood that cross-section in a plane perpendicular to the longitudinal axis may have shapes other than annular in alternative embodiments to match non-circular contours of section of the conduit 102 in which the check valve is located.

In embodiments of the present invention, the overall length of check valve 100 may be proximately one-half an inch, but is understood that the length of the check valve 100 may be greater than or lesser than a half inch in alternative embodiments of the present invention.

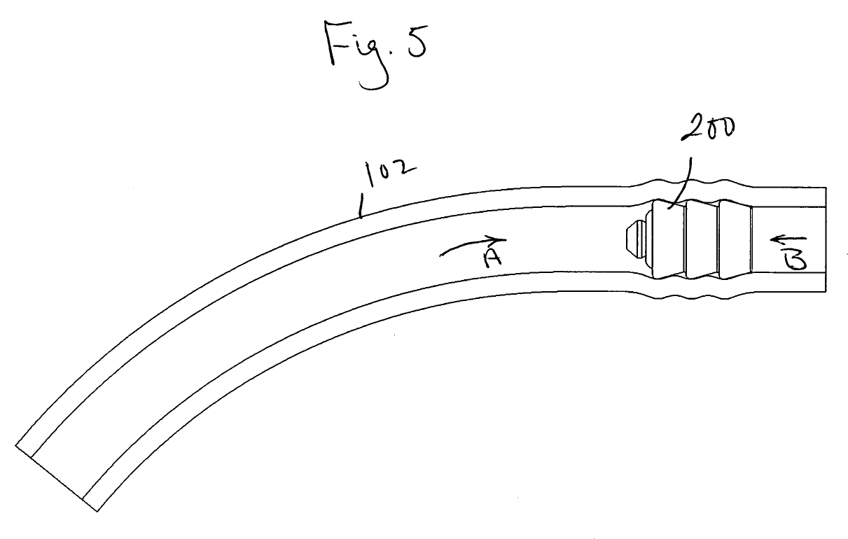

A further embodiment of the present invention is shown in FIGS. 5 through 7. This embodiment is generally the same as that described above with respect to FIGS. 1 through 4, but is provided to allow flow in the reverse direction from that shown in FIGS. 1 through 4. The components in FIGS. 5-7 which correspond to components in FIGS. 1-4 have the same reference numbers but incremented by 100. Check valve 200 of FIGS. 5 through 7 includes a casing 204 having an outer surface with barbs 224 identical to those described above. Similarly, the embodiment of FIGS. 5 through 7 includes the identical internal components, namely poppet 206, O-ring 208 and spring 216. However, in accordance with the embodiment of FIGS. 5 through 7, the shape of the surfaces on the interior of casing 204 are reversed with respect to that shown in FIGS. 1 through 4, such that the seat 220 for receiving O-ring 208 is formed in the back end 214 of casing 204 and the check valve is assembled by inserting the poppet 206 and spring 216 initially into and through the front end of casing 204 and then press fitting O-ring 208 into the slotted neck portion 210 at the back end 214 of casing 204.

Such a configuration prevents flow through conduit 102 in the direction of arrow A, but allows flow through check valve 200 in the direction of arrow B at cracking pressures described above with respect to FIGS. 1 through 4. As in the previously described embodiments, the barbed sections 224 of casing 204 prevent movement of the check valve upon insertion into conduit 102. Check valve 200 of FIGS. 5 through 7 may be the same size as and used in the same diameter conduits as the check valve 100 shown in FIGS. 1 through 4.

Although the invention has been described in detail herein, it should be understood that the invention is not limited to the embodiments herein disclosed. Various changes, substitutions and modifications may be made thereto by those skilled in the art without departing from the spirit or scope of the invention as described and defined by the appended claims.

1. A check valve capable of fitting within a conduit, a front end of the check valve being inserted first, the check valve comprising:
a barbed casing having an interior cavity;
internal components provided substantially within the interior cavity of the barbed casing, the internal components capable of moving between a first position where fluid flow is allowed through the barbed casing and a second position where fluid flow is prevented through the barbed casing, fluid flow in one direction biasing and maintaining the internal components in the first position and fluid flow in the opposite direction biasing the internal components into the second position; and
barbs provided on an outer surface of the barbed casing, the barbs capable of maintaining the check valve in a fixed locatioin at which the check valve is positioned in the conduit.

2. A check valve as recited in claim 1, wherein each barb has a narrower cross-section toward the front of the check valve and a wider cross-section toward a back of the check valve, wherein fluid flow traveling in the direction from the front of the check valve to the back of the check valve is blocked and fluid flow traveling in the opposite direction is allowed.

3. A check valve as recited in claim 1, wherein each barb has a narrower cross-section toward a back of the check valve and a wider cross-section toward the front of the check valve, wherein fluid flow traveling in the direction from the front of the check valve to the back of the check valve is blocked and fluid flow traveling in the opposite direction is allowed.

4. A check valve as recited in claim 1, wherein each barb has a narrower cross-section toward the front of the check valve and a wider cross-section toward a back of the check valve, wherein fluid flow traveling in the direction from the back of the check valve to the front of the check valve is blocked and fluid flow traveling in the opposite direction is allowed.

5. A check valve as recited in claim 1, wherein each barb has a cross-section at its widest diameter which is equal to the inner diameter of the conduit where the check valve is located or is between 0 and ⅛^{th} inch greater than the inner diameter of the conduit where the check valve is located.

6. A check valve as recited in claim 1, wherein the casing is formed of a polymer for establishing a frictional engagement with the inner surfaces of the conduit.

7. A check valve as recited in claim 1, wherein the check valve is capable of anchoring in a conduit having a ¼ inch inner diameter.

8. A check valve capable of fitting within a conduit, the check valve comprising:
a casing having an inner cavity;
a poppet provided substantially within the inner cavity of the casing, the poppet capable of moving between a first position where fluid flow is allowed through the casing and a second position where fluid flow is prevented through the casing,
a spring for biasing the poppet into the second position, fluid flow in one direction biasing and maintaining the poppet in the second position and fluid flow in the opposite direction biasing the poppet into the first position, the poppet moving into the first position if the force generated by the flow in the opposite direction is greater than the force of the spring biasing the poppet into the second position; and
a plurality of barbs provided on an outer surface of the casing, the barbs capable of maintaining the check valve in a fixed position at which the check valve is inserted in the conduit, a barb of the plurality of barbs having a generally conical shape and a first end and a second end, an outer diameter of the barb at the first end of the barb being greater than an outer diameter of the barb at the second end of the barb, the outer diameter of the barb at the first end being slightly larger than an inner diameter of the conduit into which the check valve is capable of being located, and the outer diameter of the barb at the second end being equal to or slightly less than the inner diameter of the conduit into which the check valve is capable of being located.

9. A check valve as recited in claim 8, wherein the outer diameter of the barb at the first end is between 0 and ⅛^{th} inch greater than the inner diameter of the conduit where the check valve is located.

10. A check valve as recited in claim 8, wherein the casing is formed of a polymer for establishing a frictional engagement with the inner surfaces of the conduit.

11. A check valve as recited in claim 8, wherein the check valve is capable of anchoring in a conduit having a ¼ inch inner diameter.
